(19) United States
(12) Patent Application Publication
(10) Pub. No.: US 2022/0394988 A1
(43) Pub. Date: Dec. 15, 2022

(54) FERMENTED COMPOSITIONS AND PROCESSES OF PREPARING THE SAME

(71) Applicant: COMPAGNIE GERVAIS DANONE, Paris (FR)

(72) Inventors: Fanny LARRERE, Noisy sur Ecole (FR); Anne DEPIERRIS, Breuillet (FR); Laurent MARCHAL, Villemoisson sur Orge (FR)

(21) Appl. No.: 17/633,875

(22) PCT Filed: Aug. 7, 2020
(86) PCT No.: PCT/IB2020/000666

§ 371 Date: Feb. 8, 2022

Related U.S. Application Data
(60) Provisional application No. 62/884,854, filed on Aug. 9, 2019.
(60) Provisional application No. 62/886,031, filed on Aug. 13, 2019.

(51) Int. Cl. A23C 11/10

(52) U.S. Cl. CPC A23C 11/106; A23Y 2240/75; A23Y 2220/15; A23Y 2240/41

(57) ABSTRACT

The present invention relates to fermented plant-based compositions and methods of making the same.

### FIELD OF THE INVENTION

The present invention relates to compositions comprising Lactococcus, and processes of preparing said compositions having improved taste characteristics.

### TECHNICAL BACKGROUND

There is increased interest in plant-based diets among mainstream consumers who consider themselves vegan, vegetarian or flexitarian. To cater to the dietary needs of such consumers a wide variety of plant-based analogues or alternatives to non-vegan food products are increasingly available. These include plant-based dairy alternatives such as milks, yogurts, cheeses & frozen desserts. The formulation of such products to provide a sensory and/or nutritional equivalent remains challenging.

This is especially the case in the formulation of “probiotic” food products which are also increasingly popular with consumers. According to a definition approved by a joint Food and Agriculture Organization of the United Nations/World Health Organization (FAO/WHO) expert Consultation on Health and Nutritional properties of powder milk with live lactic acid bacteria in 2001, probiotics are “live microorganisms which when administered in adequate amounts confer a health benefit on the host”. Probiotic bacteria have been described among species belonging to the genera Lactobacillus, Bifidobacterium, Streptococcus and Lactococcus, commonly used in the dairy industry. However, the addition of probiotic species, especially in the context of fermented food products can be challenging as they can introduce undesirable flavours or off-notes to products.

Diacetyl (butanedione or butane-2,3-dione) and acetoin (3-hydroxybutanone or acetyl methyl carbinol) are commonly used food flavouring compounds that provide the characteristic flavor of butter and are often added to butter substitutes such as margarine to provide buttery flavours.

Diacetyl is produced industrially by dehydrogenation of 2,3-butanediol. However both diacetyl and acetoin are also by-products of lactic fermentation by certain strains of bacteria and various other micro-organisms. Heterfermentative lactic acid bacteria are able to produce diacetyl and acetoin as by-products alongside lactic acid.

There exists a need in the art for means for the preparation of plant-based dairy analogues having sensory characteristics emulating that of dairy products. The present invention is based on the surprising finding that Lactococcus can improve the dairy-like sensory characteristics of plant-based dairy analogues, and that these properties may increase during shelf-life.

### SUMMARY OF VARIOUS EMBODIMENTS

Plant-based compositions comprising Lactococcus and processes for the preparation thereof are disclosed. The inventors found that Lactococcus, when used (optionally, in combination with fructose positive S. thermophilus) for the preparation of fermented food products, provide a composition having improved taste characteristics.

In a first aspect, the present invention provides fermented plant-based compositions comprising Lactococcus (hereinafter also referred to as “compositions of the invention”). In one embodiment, the fermented plant-based composition comprises Lactococcus and further comprising S. thermophilus, preferably fructose positive S. thermophilus.

In a second aspect, the present invention a method for the preparation of a fermented plant-based composition. In one embodiment, the present invention provides a method for the preparation of a fermented plant-based composition comprising fermenting a mixture comprising a vegetal base, Lactococcus and S. thermophilus, preferably fructose positive S. thermophilus.

In a third aspect, the present invention provides further composition comprising Lactococcus and S. thermophilus strains.

In a fourth aspect, the present invention provides a Lactococcus strain.

### DETAILED DESCRIPTION OF VARIOUS EMBODIMENTS

As used herein, the term “ppm” shall be taken to mean “parts per million” One gram in 1 liter is 1000 ppm and one thousandth of a gram (0.001 g) in 1 liter is one ppm.

As used herein, the term “x % (w/w)” “x % w/w” is equivalent to “x g per 100 g”. Unless indicated otherwise, all % value shall be taken to indicate x % w/w.

In the context of this application, the term “at least” also includes the starting point of the open range. For example, an amount of “at least 95.00% w/w” means any amount equal to 95.00 percentage by weight or above.

In the context of this application, the term “about” defines a range of plus or minus 10% of the cited value. For example, an amount of “about 20 weight %” means any amount within the range of 18.00 to 22.00 weight %.

As used herein, the term “plant-based” shall be taken to mean a composition or product which does not comprise animal or animal-derived (e.g. mammal milk) matter.

As used herein, the adjective “dairy” shall be taken to mean a composition or product comprises or consists of mammalian milk matter, i.e. the lacteal secretion obtainable by milking.

As used herein, the terms “-free” or “free from” shall be taken to mean a composition or product which preferably does not contain a given substance but where trace amounts or contaminants thereof may be present.

As used herein, the term “added sugar” shall refer to sugars that are added during the processing of foods (e.g. plant matter processed to provide a vegetal base) as opposed to sugars naturally occurring in said foods. Added sugars include sugars (free, mono- and disaccharides), sugars from syrups and honey, and sugars from concentrated fruit or vegetable juices that are in excess of what would be expected from the same volume of 100 percent fruit or vegetable juice of the same type.

As used herein, the term “fermented plant-based” shall be taken to mean a product or composition that is the product of the acidifying fermentation of a plant-based composition by a starter culture of fermenting microorganisms, in particular bacteria, preferably lactic acid bacteria.

As used herein, the term “fermented dairy milk” shall be taken to mean a product or composition derived from dairy milk by the acidifying action of at least one lactic acid bacterium, such as a yogurt (e.g., a set, stirred or drink yogurt), or a fresh cheese such as a white cheese or a “petit-Suisse”. It can be also be a strained fermented milk such as a strained yoghurt (e.g., a concentrated or Greek-style yoghurt).

As used herein, the terms plant-based alternative, analogue or substitute shall be taken to mean a plant-based food or beverage composition that is formulated to simulate the organoleptic and/or nutritional qualities of a non plant-based product. Accordingly, a “plant-based fermented milk alternative” shall be taken to mean a plant-based food or beverage composition that is formulated to simulate the organoleptic and/or nutritional qualities of fermented dairy milk. A “plant-based yogurt” shall be taken to mean a plant-based food or beverage composition that is formulated to simulate the organoleptic and/or nutritional qualities of fermented dairy yogurt.

The term “dairy yogurt” or “plant-based yogurt” as used herein shall be taken to mean fermented dairy or plant-based milk respectively obtained by the acidifying lactic fermentation of the bacteria Lactobacillus delbrueckii subsp. bulgaricus and Streptococcus thermophilus (also referred to as Streptococcus salivarius subsp. thermophilus), which must be viable in the finished product at a minimum CFU. In certain countries, regulations allow the addition of further lactic acid bacteria to yoghurt such as but not limited to strains of Bifidobacterium and/or Lactobacillus acidophilus and/or Lactobacillus casei. These additional lactic acid bacteria strains are intended to impart various properties to the finished product, such as that of providing organoleptic qualities, favoring equilibrium of intestinal flora or modulating the immune system.

As used herein, the term “strained composition” shall be taken to mean a fermented composition which has been subjected to a post-fermentation separation method.

As used herein, the term “spoonable” shall be taken to mean a solid or semi-solid that may be consumed by means of a spoon or other utensil.

As used herein, the term “fermentation” shall be taken to mean the metabolism of a substance by microorganisms, e.g. bacteria, yeasts, or other microorganisms.

As used herein, the term “heterofermentative” shall be taken to mean the obligate or facultative metabolism by microorganisms with both lactic and acetic acid as by-products.

As used herein, the term “homofermentative” shall be taken to mean the obligate or facultative metabolism by microorganisms with lactic but not acetic acid as a by-product.

As used herein, the term “diacetyl producing” shall be taken to refer to a microorganism with diacetyl as a metabolism by-product.

As used herein, the term “acetoin producing” shall be taken to refer to a microorganism with acetoin as a metabolism by-product.

As used herein, the term “increased milky” shall be taken to mean an increase in milky taste as compared to a product fermented without Lc. lactis. As used herein the term “increased buttery” shall be taken to mean an increase in buttery taste as compared to a product fermented without Lc. lactis. As used herein the term “increased dairy notes” shall be taken to mean an increase in dairy taste as compared to a product fermented without Lc. lactis. As used herein the term “increased creamy notes” shall be taken to mean an increase in creamy taste as compared to a product fermented without Lc. lactis. As used herein, the term “decreased bitterness” shall be taken to mean a decrease in bitter taste as compared to a product fermented without Lc. lactis.

As used herein, the term “fructose positive” shall be taken to mean the obligate or facultative metabolism of fructose by microorganisms.

As used herein, the term “cfu” or “CFU” shall be taken to be an abbreviation of the term “colony forming unit”.

As used herein, the term “CNCM I-” followed by a 4 digit number shall be taken to refer to a strain deposited at the Collection Nationale de Cultures de Microorganismes (CNCM) 25 rue du Docteur Roux, Paris, France under the Budapest Treaty with an accession number corresponding to said 4 digit number, e.g. CNCM 1-1631. As used herein, reference to a bacterial strain or species shall be taken to include functionally equivalent bacteria derived therefrom such as but not limited to mutants, variants or genetically transformed bacteria.

The following strains have been deposited at the Collection Nationale de Cultures de Microorganismes (CNCM) (Institut Pasteur, 25 Rue du Docteur Roux, Paris, France). The deposits were made in accordance with the Budapest Treaty on the International Recognition of the Deposit of Microorganisms for the Purposes of Patent Procedure. As provided therein the applicant requests that a sample of the deposited micro-organisms only be made available to an independent expert, until the date on which the patent may be granted.
Lactobacillus delbrueckii subsp. bulgaricus CNCM 1-1632, deposit date 24 Oct. 1995.
Lactobacillus delbrueckii subsp. bulgaricus CNCM 1-1519, deposit date 30 Dec. 1994.
Streptococcus thermophilus CNCM-1630, deposit date 24 Oct. 1995.
Lactococcus lactis subsp. lactis CNCM-1631, deposit date 24 Oct. 1995.
Bifidobacterium animalis subsp. lactis CNCM-2494, deposit date 20 Jun. 2000.
Streptococcus thermophilus strain CNCM 1-1520, deposit date 30 Dec. 1994.
Lactococcus lactis subsp. lactis CNCM 1-3437, deposit date 25 May 2005.
Lactococcus lactis subsp. cremoris CNCM 1-3558, deposit date 20 Jan. 2006.

The present invention relates to plant-based composition, and processes comprising Lactococcus. In some embodiments, the compositions and processes described herein comprise one or more of the strains identified in the preceding paragraph.

### Plant-Based Compositions

In a first aspect, the present invention provides fermented plant-based compositions comprising Lactococcus.

The compositions of the invention are suitable for use in edible compositions. Accordingly, in one embodiment, the present invention provides an edible fermented plant-based compositions suitable for human consumption or ingestion, preferably by oral means comprising Lactococcus.

The composition comprises or consists of comestible matter. It is particularly preferred that the compositions of embodiments of the invention are substantially free of pathogenic or toxicogenic matter. In a particularly preferred embodiment, the composition according to the invention may be a non-therapeutic composition, preferably a nutraceutical composition, a nutritional composition and/or a food product. It is particularly preferred that the food product is a fermented food product, preferably a fermented dairy composition or plant-based alternative thereto. Further compositions according to embodiments of the invention also include food additives, food ingredients, nutritional formulas, baby foods, infant milk formulas and infant follow-on formulas.

In one embodiment, the present invention provides a fermented plant-based dairy-alternative composition comprising i) a fermented vegetal base, ii) Lactococcus species and optionally iii) S. thermophilus and/or L. bulgaricus.

Preferably, the fermentation of said vegetal base has been achieved by the acidifying action of lactic acid bacteria comprising the Lactococcus species.

Preferably, said composition is a packaged food product. Preferably, the fermented plant-based dairy-alternative food product according to embodiments of the invention, is stored, transported and/or distributed at a temperature of from 1° C. to 10° C. for at least about 1, 5, 6, 7, 8, 9, 10, 12, 14, 16, 18, 20, 22, or 24 days prior to consumption.

In an alternative embodiment, the present invention provides compositions of the invention comprising i) a fermented vegetal base, ii) Lactococcus, and iii) fructose positive S. thermophilus.

In other embodiments, the present invention provides fermented compositions comprising free lactic and acetic acid, wherein the weight ratio of lactic to acetic acid is 1.5 or higher. Preferably, the weight ratio of lactic to acetic acid is 1.6, 1.7, 1.8, 1.9, 2, 2.5 or higher. In other embodiments, the weight ratio of lactic to acetic acid is between 1.5 and 4, more preferably between 1.5 and 3.

Preferably, the fermented compositions of the invention comprise above about 230 mg per 100 g by weight free lactic acid, more preferably above about 250 mg per 100 g by weight free lactic acid. In other embodiments, the composition comprises about 230 mg-500 mg per 100 g by weight free lactic acid, more preferably 250 mg-350 mg per 100 g.

Preferably, the fermented compositions of the invention comprise less than about 200 mg per 100 g by weight free acetic acid, more preferably less than about 150 mg per 100 g by weight free acetic acid. In embodiments, the composition comprises about 0.1 mg-200 mg per 100 g by weight free acetic acid, more preferably 0.1 mg-150 mg per 100 g.

In other embodiments, the fermented compositions of the invention are free from, or do not comprise, added sugars. Preferably, the fermented compositions of the invention comprise less than 5 mg/100 g sucrose, more preferably less than 4, 3, 2 or 1 mg/100 g sucrose. It is particularly preferred that the compositions of the invention are free from sucrose.

Preferably, the fermented compositions of the invention comprise less than 5 mg/100 g glucose, more preferably less than 3 mg/100 g and most preferably less than 2 mg/100 g. In other embodiments, the fermented compositions of the invention are free from, or do not comprise, galactose and fructose. Optionally, the fermented compositions of the invention comprise less than about 350 mg/100 g total sum raffinose, stachyose and verbacose, more preferably less than about 300 mg/100 g.

Preferably, the fermented compositions of the invention comprise 0.1-5 mg/100 g glucose, more preferably 0.1-3 mg/100 g and most preferably 0.1-2 mg/100 g. Optionally, the fermented compositions of the invention comprise 0.1-350 mg/100 g total sum raffinose, stachyose and verbacose, more preferably 0.1-300 mg/100 g.

Preferably, the fermented compositions of the invention comprise diacetyl and/or acetoin. In embodiments the vegetal base prior to fermentation is free from diacetyl and acetoin.

In other embodiments, the fermented compositions of the invention comprise at least 10⁵ cfu/g, more preferably at least 10⁶ cfu/g, such as at least 10⁷ cfu/g, e.g. at least 10⁸ cfu/g, such as at least 10⁹ cfu/g, e.g. at least 10¹⁰ cfu/g, such as at least 10¹¹ cfu/g of each bacterial strain.

In other embodiments, the Lactococcus are diacetyl and/or acetoin producing strains thereof. In other embodiments, the Lactococcus comprises Lactococcus lactis (hereinafter referred to as Lc. lactis or L. lactis), preferably selected from the group consisting of L. lactis cremoris, L. lactis lactis and/or combinations thereof. In a preferred embodiment, the Lactococcus comprises one or more strains of Lactococcus lactis lactis biovar diacetylactis. In other embodiments, the Lactococcus comprises one or more strains selected from the group consisting of CNCM 1-1631; CNCM 1-3437; CNCM 1-3558 and/or combinations thereof. It is particularly preferred that the Lactococcus comprise CNCM 1-1631.

The fermented plant-based compositions according to embodiments of the invention preferably comprise at least 10⁵, 10⁶, 10⁷, 10⁸ or 10⁹ CFU/g Lactococcus. In other embodiments, the plant-based compositions of the invention comprise 10⁵ to 10¹² or 10⁶ to 10¹⁰ colony forming unit (CFU) Lactococcus per gram of composition. In embodiments, the present invention provides fermented plant-based compositions comprising Lactococcus lactic (and methods for the preparation thereof), wherein the count of said Lactococcus is reduced by less than 1, 0.8, 0.6, 0.4 or 0.2 Log CFU/g, over 35 days of storage from end of fermentation at a temperature of 1° C. to 10° C.

It is particularly preferred that the fructose positive S. thermophilus comprise CNCM I-1520.

In other embodiments, the fermented compositions of the invention preferably comprise at least 10⁵, 10⁶, 10², 10⁸ or 10⁹ CFU/g L. bulgaricus. In other embodiments, the plant-based compositions of the invention comprise 10⁵ to 10¹² or 10⁶ to 10¹⁰ colony forming unit (CFU) L. bulgaricus per gram of composition.

The fermented compositions of the invention according to embodiments of the invention preferably comprise at least 10⁵, 10⁶, 10², 10⁸ or 10⁹ CFU/g S. thermophilus, preferably fructose positive S. thermophilus. In other embodiments, the plant-based compositions of the invention comprise 10⁵ to 10¹² or 10⁶ to 10¹⁰ colony forming unit (CFU) S. thermophilus, preferably fructose positive S. thermophilus per gram of composition.

Preferably, said S. thermophilus are characterized in that they are capable of fermenting the vegetal base in its unfermented state to the pH of the composition (preferably equal to or lower than 5, 4.9, 4.8, 4.7 or most preferably equal to or lower than 4.6) by culturing at a temperature of 35° C.-41° C. for less than or equal to 8 hours at an inoculation rate sufficient to provide the final CFU of said bacteria in said product.

In other embodiments, said S. thermophilus are characterized in that they are capable of fermenting said vegetal base to a pH of equal to or lower than 4.6 by culturing at a temperature of 35° C.-41° C. for less than or equal to 8 hours at an inoculation rate of 10⁵-10² CFU/g of vegetal base.

Optionally the fermented compositions of the invention may further comprise one or more strains of bacteria selected for their potential probiotic properties, preferably Bifidobacterium and/or lactic acid bacteria. The fermented compositions of the invention according to embodiments of the invention preferably comprise at least 10⁵, 10⁶, 10², 10⁸ or 10⁹ CFU/g of each of said “probiotic” strains. Accordingly in embodiments the fermented compositions of the invention may further comprise one or more strains of bacteria selected from the group consisting of Bifidobacterium animalis; Bifidobacterium longum; Bifidobacterium breve; Bifidobacterium bifidum; Lactobacillus acidophilus; Lactobacillus buchneri; Lactobacillus casei; Lactobacillus plantarum; Lactobacillus reuteri; Lactobacillus johnsonii; Lactobacillus helveticus; Lactobacillus brevis; Lactobacillus rhamnosus and/or combinations thereof. In embodiments said strains are selected from the group comprising Bifidobacteria; Lactobacillus acidophilus; Lactobacillus casei and/or combinations thereof.

In preferred embodiments, the Bifidobacteria comprises Bifidobacterium animalis, preferably Bifidobacterium animalis lactic and/or Bifidobacterium animalis animalis, more preferably strain CNCM 1-2494.

The fermented compositions of the invention according to embodiments of the invention preferably comprise at least 10⁵, 10⁶, 10², 10⁸ or 10⁹ CFU/g S. thermophilus, preferably fructose positive S. thermophilus. In other embodiments, the plant-based compositions of the invention comprise 10⁵ to 10¹² or 10⁶ to 10¹⁰ colony forming unit (CFU) Bifidobacteria, preferably B. animalis per gram of composition.

Preferably, the fermented composition of the invention is prepared by culture of the vegetal base at a suitable temperature with the microorganisms ii) and optionally iii) to provide the required reduction in pH, preferably by culturing for less than or equal to 12, 10, 8, 7, 6, 5 or 4 hours.

In one embodiment, the vegetal base is an aqueous suspension comprising water and plant-matter selected from the group consisting of legumes, nuts, seeds, cereals and/or combination thereof. Particularly preferred is a base free from, or do not comprise, added sugar, where the total carbohydrate content of the vegetal base is derived from plant-matter selected from the group consisting of legumes, nuts, seeds, cereals and/or combination thereof. In preferred embodiments, the plant-matter has not been subjected to a step of hydrolysis (e.g. enzymatic hydrolysis) and thus the vegetal base does not comprise or is free-from fully or partially hydrolyzed hydrolysed plant-matter such as fully or partially hydrolyzed cereal. In preferred embodiments the vegetal base does not comprise almond milk. In embodiments said cereal is selected from the group consisting of rice, barley, wheat, and oat.

In other embodiments, the plant-matter comprises legumes, and most preferably, pulse or pulses. In other embodiments, the pulses are selected from the group consisting of split peas, field peas, dry peas, lentil, chickpeas, garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, soy and/or lupin. In preferred embodiments, the pulses are pea and/or chickpea.

In other embodiments, the nuts are selected from the group consisting of almonds, cashews, pecans, macadamias, hazelnuts, pistachio, walnuts or combinations thereof.

In other embodiments, the seeds are selected from the group consisting of hemp, pumpkin, quinoa, sesame, tiger nut, flax, chia, sunflower, coconut or combinations thereof.

In other embodiments, said cereals are selected from the group consisting of wheat, rye, spelt, barley, oat, millet, sorghum, rice, teff and combinations thereof.

Processes for the preparation of such suspensions are known in the art and typically comprise mechanical and/or enzymatic disruption of the plant-matter and hydration and/or combination with a solution, followed by mechanical separation of an aqueous fraction from starchy and/or fibrous matter, e.g., by decantering, centrifugation or filtration.

For example, the plant-matter may be milled, ground, soaked, dehulled, mixed with water, optionally enzymatic hydrolysed and/or homogenized etc. in order to produce a suitable aqueous composition.

In other embodiments, the plant matter may be a seed or nut butter such as sunflower, sesame, soy, almond, cashew, hazelnut or peanut butter. Processes for the preparation of nut butters typically comprise wet or dry grinding roasted or unroasted nuts to a paste having a particle size suitable for the preparation of nut beverages.

In other embodiments, the plant matter may be a hydrolyzed cereal suspension such as an oat milk or syrup. Processes for the preparation of such cereal suspensions typically comprise mixing an oat material (such as rolled oats, milled oats, oat flour or oatmeal) with water and treated enzymatically by amylases to hydrolyze starch followed by removal of suspended matter.

Preferably, the vegetal base prior to fermentation comprise less than 5 mg/100 g glucose, more preferably less than 3 mg/100 g and most preferably less than 2 mg/100 g. Preferably, the vegetal base prior to fermentation comprise less than 650 mg/100 g sucrose, more preferably less than 550 mg/100 g and most preferably less than 500 mg/100 g. In other embodiments, the vegetal base prior to fermentation are free from, or do not comprise, galactose and fructose. Optionally, the vegetal base prior to fermentation comprise less than about 500 mg/100 g total sum raffinose, stachyose and verbacose, more preferably less than about 450 mg/100 g.

Preferably, the vegetal base prior to fermentation comprise 0.1-5 mg/100 g glucose, more preferably 0.1-3 mg/100 g and most preferably 0.1-2 mg/100 g. Preferably, the vegetal base prior to fermentation comprise 0.1-650 mg/100 g sucrose, more preferably 0.1-550 mg/100 g and most preferably 0.1-500 mg/100 g. Optionally, the vegetal base prior to fermentation comprise 0.1-500 mg/100 g total sum raffinose, stachyose and verbacose, more preferably 0.1-450 mg/100 g.

In particular embodiments, the vegetal base is a plant-based dairy analogue or dairy substitute beverage such as milk or cream preferably a plant-based milk, such as soy, nut, oat or coconut milk.

Processes for the preparation of said beverages typically comprise the incorporation of suitable plant-based matter (e.g. oat syrup, nut butter) with water and other ingredients such as emulsifiers, stabilizing and flavoring agents. In particular embodiments, other ingredients may include one or more hydrocolloids (e.g., gellan gum, guar gum, locust bean gum, and xanthan gum), one or more salts (e.g., sea salt (e.g., sodium chloride), a potassium phosphate (e.g., monopotassium phosphate (KH2PO4), dipotassium phosphate (K2HPO4), tripotassium phosphate (K3PO4) etc.), a sodium phosphate (e.g., disodium phosphate (Na2HPO4)), a calcium phosphate (e.g., tricalcium phosphate Ca3(PO4)2), and/or any other suitable emulsifying, flavoring, stabilizing, and/or buffering agent or combination of agents), and lecithin. Other ingredients may also include nutritional supplements such as vitamin A, vitamin B2, vitamin B12, vitamin D, vitamin E, zinc, fiber, protein, calcium, potassium, phosphorus, fatty acids, (e.g., omega 3, omega 6, etc.).

In other embodiments, the vegetal base may comprise soy milk. Processes for the preparation of soy milk typically comprise hydrating whole or defatted soybeans (e.g. soaking in water), heating, grinding to obtain slurry, and removing the okara (soy pulp fiber) from the soy milk by a method such as filtration. For example, a soy milk preparation known by the name of “tonyu” may be used for producing the fermented product of the invention. Tonyu is obtained from whole soybeans and is the subject of an AFNOR standard (NF V 29-001). Briefly, to obtain tonyu, soybeans are shelled and then mixed with water and ground hot. The ground product is separated after settling out so as to separate the solid residue, called “okara”, from the soy milk, which constitutes the tonyu.

In one embodiment, it is preferred that the vegetal base does not contain animal, soy, gluten, dairy matter and/or combinations thereof.

In one embodiment, the vegetal base may be enriched or fortified with further components or nutrients such as but not limited to vitamins, minerals, trace elements or other micronutrients.

Preferably, the compositions of the invention comprise a protein content of at least about 2.5%, more preferably at least about 3% or 3.5%, most preferably 4%-5% (w/w). Preferably, the composition has a pH equal to or lower than 5, 4.9, 4.8, 4.7 or most preferably equal to or lower than 4.6. In embodiments the composition has a pH preferably between about 4 and about 4.8, and more preferably between about 4.5 and about 4.8.

Preferably, the compositions of the invention have a viscosity lower than 200 mPa·s, more preferably lower than 100 mPa·s and most preferably lower that 60 mPa·s, at 10° C., at a shear rate of 64 s−1. In other embodiments, the composition has a viscosity range of 1 to 200 mPa·s, 1 to 100 mPa·s, or 1 to 60 mPa·s, at 10° C., at a shear rate of 64 s−1. In other embodiments, the composition has a viscosity range of 10 to 200 mPa·s, 10 to 100 mPa·s, or 10 to 60 mPa·s, at 10° C., at a shear rate of 64 s−1. In other embodiments, the composition has a viscosity range of 30 to 200 mPa·s, 30 to 100 mPa·s, or 30 to 60 mPa·s, at 10° C., at a shear rate of 64 s−1.

The fermented plant-based composition according to embodiments of the invention is preferably a plant-based fermented milk alternative. In other embodiments, said composition is an alternative of a product selected from the group comprising yogurt, set yogurt, stirred yogurt, pourable yogurt, yogurt drink, frozen yogurt, kefir, buttermilk, quark, sour cream, fresh cheese and cheese. In one embodiment, the composition is a drinkable composition, more preferably a plant-based alternative of a fermented milk drink such as but not limited to a yogurt drink, kefir etc. In an alternative embodiment, the composition is a composition that is spoonable, such as a plant-based alternative of a set or stirred yogurt or equivalent thereof.

In one embodiment, the fermented plant-based composition is a strained fermented plant-based composition.

Preferably, the fermented plant-based composition according to embodiments of the invention, is stored, transported and/or distributed at a temperature of from 1° C. to 10° C. for at least about 24 hours, 48 hours or 72 hours prior to consumption. In other embodiments, the fermented plant-based composition is stored, transported and/or distributed at a temperature of from 1° C. to 10° C. for at least about 1, 5, 6, 7, 8, 9, 10, 12, 14, 16, 18, 20, 22, or 24 days prior to consumption.

Preferably, the fermented plant-based composition according to embodiments of the invention, may be stored, transported and/or distributed at a temperature of from 1° C. to 10° C. for at least about 10 days, at least about 20 days, at least about 30 days, at least about 60 days or at least about 90 days from packaging and remain suitable for consumption.

Preferably, the composition is a packaged product that comprises at least 10⁶, more preferably at least 10⁷ and most preferably at least 10⁸ colony forming unit (CFU) Lactococcus per gram (g) of composition subsequent to storage, transport and/or distribution at a temperature of from 1° C. to 10° C. for at least about 10 days, at least about 20 days, at least about 30 days, at least about 60 days or at least about 90 days from packaging.

In other embodiments, the composition is a packaged product that comprises 10⁵ to 10¹² or 10⁶ to 10¹⁰ colony forming unit (CFU) Lactococcus per gram (g) of composition subsequent to storage, transport and/or distribution at a temperature of from 1° C. to 10° C. for at least about 10 days, at least about 20 days, at least about 30 days, at least about 60 days or at least about 90 days from packaging.

In other embodiments, the composition of the invention further comprises an intermediate preparation. They are typically used to modify the taste, mouthfeel and/or texture of plant-based fermented milk alternatives. They can used also to introduce some additives such as nutrients. They typically comprise sweetening agents, flavors, color modifiers, cereals and/or fruit. Intermediate fruit preparations are for example slurries or fruit preparations. Flavors include for example fruit flavors, vanilla flavors, caramel flavors, coffee flavors, chocolate flavors.

Fruit preparations typically comprise fruits, as used herein the term “fruit” refers to any fruit form, including for example full fruits, pieces, purees, concentrates, juices etc.

The intermediate preparation or slurry typically comprises a stabilizing agent, having at least one stabilizer. The stabilizing agent can comprise at least two stabilizers. Such stabilizers are known to the one skilled in the art. They typically help in avoiding phase separation of solids, for examples of fruits or fruits extracts and/or in avoiding syneresis. They typically provide some viscosity to the composition, for example a viscosity (Bostwick viscosity at 20° C.) of from 1 to 20 cm/min, preferably of from 4 to 12 cm/min.

The stabilizing system or the stabilizer can for example be a starch, a pectin, a guar, a xanthan, a carrageenan, a locust bean gum, or a mixture thereof. The amount of stabilizing system is typically from 0.5 to 5% by weight.

The intermediate preparation can typically comprise organoleptic modifiers. Such ingredients are known by the one skilled in the art.

The organoleptic modifiers can be for example sweetening agents different from sugar, coloring agents, cereals and/or cereal extracts.

Examples of sweetening agents are ingredients referred to as High Intensity Sweeteners, such as sucralose, acesulfamK, aspartam, saccharine.

Examples of fruits include for example strawberry, peach, apricot, mango, apple, pear, raspberry, blueberry, blackberry, passion, cherry, and mixtures or associations thereof, such as peach-passion.

The fruits can be for example provided as:
frozen fruit cubes, for example 10 mm fruit cubes, for example Individual Quick Frozen fruit cubes, for example strawberry, peach, apricot, mango, apple, pear fruit cubes or mixtures thereof,
aseptic fruit cubes, for example 10 mm fruit cubes, for example strawberry, peach, apricot, mango, apple or pear fruit cubes or mixtures thereof,
fruit purees, for example fruit purees concentrated from 2 to 5 times, preferably 3 times, for example aseptic fruit purees, for example strawberry, peach, apricot, mango, raspberry, blueberry or apple fruit purees or mixtures thereof,
single aseptic fruit purees, for example strawberry, raspberry, peach, apricot, blueberry or apple single aseptic fruit purees or mixture thereof,
frozen whole fruits, for example Individual Quick Frozen whole fruits, for example blueberry, raspberry or blackberry frozen whole fruits, or mixtures thereof,
mixtures thereof.

The ingredients and/or components of the intermediate preparation and the amounts thereof can be typically such that the composition has a brix degree of from 1 to 65 brix, for example from 1 to 10 brix, or from 10 to 15 brix, or from 15 to 20 brix, or from 20 to 25 brix, or from 25 to 30 brix, or from 30 to 35 brix, or from 35 to 40 brix, or from 40 to 45 brix, or from 45 to 50 brix, or from 50 to 55 brix, or from 55 to 60 brix, or from 55 to 60 brix, or from 60 to 65 brix.

A fruit preparation can for example comprise fruit in an amount of from 30% to 80% by weight, for example from 50 to 70% by weight.

The intermediate preparation can comprise water. It is mentioned that a part of the water can come from ingredients used to prepare the fruit preparation, for example from fruits or fruit extracts or from a phosphoric acid solution.

The fruit preparation can comprise pH modification agents such as citric acid. The fruit preparation can have a pH of from 2.5 to 5, preferably of from 2.8 to 4.2.

Typically, a fruit preparation can be added in an amount of 5-35% by weight with reference to the total amount of composition. In other embodiments, the composition of the invention comprises up to about 30% (w/w) of said intermediate preparation, e.g., up to about 10%, 15%, 20%, 25% (w/w). In one embodiment, the composition according to embodiments of the invention comprise 1% to 30% (w/w) of said intermediate preparation. In alternative embodiments, the composition comprises 1% to 25% (w/w) of said intermediate preparation. In further alternative embodiments, the composition comprises 1% to 20% (w/w) of said intermediate preparation. In additional embodiments, the composition comprises 1% to 15% (w/w) of said intermediate preparation. In further additional embodiments, the composition comprises 1% to 10% (w/w) of said intermediate preparation.

Preferably, the composition, according to embodiments of the invention is a packaged product provided in a sealed or sealable container containing about 50 g, 60 g, 70 g, 75 g, 80 g, 85 g, 90 g, 95 g, 100 g, 105 g, 110 g, 115 g, 120 g, 125 g, 130 g, 135 g, 140 g, 145 g, 150 g, 200 g, 300 g, 320 g or 500 g or about 1 oz, 2 oz, 3 oz, 4 oz, 5 oz, 6 oz or 12 oz product by weight.

In other embodiments, the composition is a packaged product provided in a sealed or sealable container containing about 50 g to 500 g, 60 g to 500 g, 70 g to 500 g, 75 g to 500 g, 80 g to 500 g, 85 g to 500 g, 90 g to 500 g, 95 g to 500 g, 100 g to 500 g, 105 g to 500 g, 110 g to 500 g, 115 g to 500 g, 120 g to 500 g, 125 g to 500 g, 130 g to 500 g, 135 g to 500 g, 140 g to 500 g, 145 g to 500 g, 150 g to 500 g, 200 g to 500 g, 300 g to 500 g, 320 g to 500 g or 500 g product by weight. In other embodiments, the composition is provided in a sealed or sealable container containing about 1 oz to 12 oz, 2 oz to 12 oz, 3 oz to 12 oz, 4 oz to 12 oz, 5 oz to 12 oz, 6 oz to 12 oz or 12 oz product by weight.

### Processes for the Preparation of Fermented Plant-Based Compositions

In a second aspect, the present invention provides processes for the preparation of fermented plant-based compositions (preferably a food product) of the invention comprising inoculating a vegetal base with Lactococcus and optionally S. thermophilus and fermenting.

It is preferred that in embodiments of processes or uses of the invention said fermented plant-based composition comprises at least 10⁶, 10⁷, 10⁸ or 10⁹ CFU/g Lactococcus.

It is particularly preferred that in embodiments of processes or uses of the invention said bacterial strains are in the form of an inoculum or mixture thereof as described according to the present invention.

The processes or uses of the invention may be carried out as a method comprising the following steps:
a) providing a mixture comprising:
   i) a vegetal base, and
   ii) Lactococcus species
b) fermenting the mixture to provide a fermented plant-based dairy-alternative food product,

In other embodiments, said mixture further comprises iii) at least one strain of lactic acid bacteria, preferably S. thermophilus and/or L. bulgaricus. Optionally iii) at least one strain of lactic acid bacteria may further comprise one or more strains of bacteria selected from the group consisting of Bifidobacterium animalis; Bifidobacterium longum; Bifidobacterium breve; Bifidobacterium bifidum; Lactobacillus acidophilus; Lactobacillus buchneri; Lactobacillus casei; Lactobacillus plantarum; Lactobacillus reuteri; Lactobacillus johnsonii; Lactobacillus helveticus; Lactobacillus brevis; Lactobacillus rhamnosus and/or combinations thereof. In embodiments said strains are selected from the group comprising Bifidobacteria; Lactobacillus acidophilus; Lactobacillus casei and/or combinations thereof.

In embodiments the Bifidobacterium animalis are selected from the group consisting of Bifidobacterium animalis subsp. animalis or Bifidobacterium animalis subsp. Lactis, strain CNCM 1-2494 and/or combinations thereof.

In other embodiments, the processes or uses of the invention may be carried out as a method comprising the following steps:
a) providing a mixture comprising:
   i) vegetal base,
   ii) Lactococcus species, and
   iii) S. thermophilus, preferably fructose positive S. thermophilus
b) fermenting the mixture to provide a fermented plant-based composition.

In other embodiments, the process according to the invention further comprises c) packaging and storing at a temperature of from 1° C. to 10° C. for at least about 24 hours, 48 hours or 72 hours prior to consumption.

In other embodiments, the fermented plant-based composition is stored, transported and/or distributed at a temperature of from 1° C. to 10° C. for at least about 1, 5, 6, 7, 8, 9, 10, 12, 14, 16, 18, 20, 22, or 24 days prior to consumption.

Preferably, the fermented compositions of the invention comprise diacetyl and/or acetoin. It is further preferred that the vegetal base prior to fermentation is free from diacetyl and acetoin.

Vegetal bases as described above may be used in the processes of the invention. In one embodiment, the vegetal base is an aqueous suspension comprising water and plant-matter (as described above) selected from the group consisting of legumes, nuts, seeds, cereals and/or combination thereof. Particularly preferred is a base free from, or that does not comprise, added sugar, where the total carbohydrate content of the vegetal base is derived from plant-matter selected from the group consisting of legumes, nuts, seeds, cereals and/or combination thereof. In preferred embodiments, the plant-matter has not been subjected to a step of hydrolysis (e.g. enzymatic hydrolysis) and thus the vegetal base is free-from fully or partially hydrolyzed plant-matter such as fully or partially hydrolyzed cereal. In preferred embodiments the vegetal base does not comprise almond milk. In embodiments said cereal is selected from the group consisting of rice, barley, wheat, and oat.

Preferably, the vegetal base prior to fermentation comprise less than 5 mg/100 g glucose, more preferably less than 3 mg/100 g and most preferably less than 2 mg/100 g. Preferably, the vegetal base prior to fermentation comprise less than about 650 mg/100 g sucrose, more preferably less than 550 mg/100 g and most preferably less than 500 mg/100 g. In other embodiments, the vegetal base prior to fermentation are free from or do not comprise galactose and fructose. Optionally, the vegetal base comprises less than 500 mg/100 g total sum raffinose, stachyose and verbacose; more preferably less than 450 mg/100 g.

Preferably, the vegetal base prior to fermentation comprise 0.1-5 mg/100 g glucose, more preferably 0.1-3 mg/100 g and most preferably 0.1-2 mg/100 g. Preferably the vegetal base prior to fermentation comprise less than about 650 mg/100 g sucrose, more preferably 0.1-550 mg/100 g and most preferably 0.1-500 mg/100 g. Optionally, the vegetal base comprises 0.1-500 mg/100 g total sum raffinose, stachyose and verbacose; more preferably 0.1-450 mg/100 g.

Preferably, fermented plant-based compositions are prepared using vegetal base that has been subjected to heat treatment at least equivalent to pasteurization. Preferably, the heat treatment is carried out prior to the preparation of the composition.

In other embodiments, the mixture comprises at least 10⁵ cfu/g, more preferably at least 10⁶ cfu/g, such as at least 10² cfu/g, of each bacterial strain.

In other embodiments, the mixtures comprise at least 10⁵ cfu/g, more preferably at least 10⁶ cfu/g, such as at least 10² cfu/g of each bacterial strain of ii) Lactococcus and iii) L. bulgaricus and/or S. thermophilus, in embodiments fructose positive S. thermophilus. The fermented plant-based compositions according to embodiments of the invention preferably comprise at least 10⁵, 10⁶, 10², 10⁸ or 10⁹ CFU/g Lactococcus. In other embodiments, the plant-based compositions of the invention comprise 10⁵ to 10¹² or 10⁶ to 10¹⁰ colony forming unit (CFU) Lactococcus per gram of composition.

In other embodiments, the Lactococcus are diacetyl and/or acetoin producing strains thereof. In other embodiments, the Lactococcus comprises L. lactis, preferably selected from the group consisting of L. lactis cremoris, L. lactis lactis and/or combinations thereof. In a preferred embodiment, the Lactococcus comprises one or more strains of Lactococcus lactis lactis biovar diacetylactis. In other embodiments, the Lactococcus comprises one or more strains selected from the group consisting of CNCM 1-1631; CNCM 1-3437; CNCM 1-3558 and/or combinations thereof. It is particularly preferred that the Lactococcus comprise CNCM 1-1631. In embodiments, the present invention provides fermented plant-based compositions comprising Lactococcus lactis (and methods for the preparation thereof), wherein the count of said Lactococcus is reduced by less than 1, 0.8, 0.6, 0.4 or 0.2 Log CFU/g, over 35 days of storage from end of fermentation at a temperature of 1° C. to 10° C.

The fermented plant-based compositions according to embodiments of the invention preferably comprise at least 10⁵, 10⁶, 10², 10⁸ or 10⁹ CFU/g Lactococcus. In other embodiments, the plant-based compositions of the invention comprise 10⁵ to 10¹² or 10⁶ to 10¹⁰ colony forming unit (CFU) Lactococcus per gram of composition. In a most preferred embodiment, the plant-based compositions comprise between 1×10⁶ and 2×10⁸ cfu/g Lactococcus.

It is preferred that the S. thermophilus comprise fructose positive strains. It is preferred that the fructose positive S. thermophilus comprise CNCM 1-1520.

Preferably, said S. thermophilus are characterized in that they are capable of fermenting the vegetal base in its unfermented state to the pH of the composition (preferably equal to or lower than 5, 4.9, 4.8, 4.7 or most preferably equal to or lower than 4.6) by culturing at a temperature of 35° C.-41° C. for less than or equal to 8 hours at an inoculation rate sufficient to provide the final CFU of said bacteria in said product.

In one embodiment of the method of the invention, the mixture comprises at least one, two, three or more further strains of lactic acid bacteria. Optionally, the mixtures and compositions of the invention may further comprise one or more strains of Bifidobacteria, preferably selected from the group consisting of Bifidobacterium breve, Bifidobacterium bifidum, Bifidobacterium longum, Bifidobacterium infantis, Bifidobacterium animalis. In other embodiments, the Bifidobacteria comprises Bifidobacterium animalis lactis and/or Bifidobacterium animalis animalis, preferably strain CNCM 1-2494.

The selection of suitable lactic acid bacteria strains is within the scope of the skilled person and is typically a thermophillic lactic acid bacteria. Typically, a mixture or association of a plurality of strains of lactic acid bacteria may be used, typically a mixture or association of Lactobacillus and Streptococcus. For the preparation of yogurt this typically includes Lactobacillus bulgaricus (also referred to as Lactobacillus delbrueckii subsp. bulgaricus) and Streptococcus thermophilus, optionally with additional microorganisms such as but not limited to probiotic species or other species that may provide desirable organoleptic or other qualities to the composition, e.g. Lactococcus lactis.

Accordingly, in one embodiment, the mixture further comprises Lactobacillus bulgaricus, and optionally further strains of Streptococcus thermophilus.

Fermentation of the mixture is carried out by incubating the mixture at a temperature suitable for the metabolization of the vegetal base by the bacteria to provide a reduction in pH. Suitable temperatures for such fermentation are typically about 36° C. to about 45° C. and the temperature is maintained for an incubation time sufficient to provide the desired reduction in pH.

Preferably, the fermented plant-based composition is prepared by culture of the mixture to provide a reduction in pH, preferably to a pH equal to or lower than 5, 4.9, 4.8, 4.7 or 4.6. In other embodiments, the fermentation is carried out to a pH preferably between about 4 and about 4.8, and more preferably between about 4.5 and about 4.8. The pH can be adjusted by controlling the fermentation by the microorganism and stopping it when appropriate, for example by cooling.

Preferably, the fermented plant-based composition is prepared by culture of the mixture to provide a composition comprising free lactic and acetic acid, wherein the weight ratio of lactic to acetic acid is 1.5 or higher. Preferably, the weight ratio of lactic to acetic acid is 1.6, 1.7, 1.8, 1.9, 2, 2.5 or higher. In embodiments the weight ratio of lactic to acetic acid is between 1.5 and 4, more preferably between 1.5 and 3.

Preferably, the fermented plant-based composition is prepared by culture of the mixture to provide a composition substantially free from, or that does not comprise sucrose.

Preferably, the fermented plant-based composition is prepared by culture of the mixture at a suitable temperature with the microorganisms to provide the required reduction in pH, preferably by culturing for less than or equal to 12, 10, 8, 7 or 6 hours.

It is preferred that in embodiments of processes or uses of the invention said fermentation is carried out at a temperature of less than about 45° C. or 42° C., particularly preferred is a temperature of 35° C.-42° C., more preferably 39° C.-41° C. For the preparation of a fermented plant-based composition, the temperature at the start of fermentation is typically about 36° C. to about 43° C., in particular about 37° C. to about 40° C., the temperature at the end of fermentation is typically about 37° C. to about 44° C., in particular about 38° C. to about 42° C.

Subsequent to the fermentation, the fermented plant-based composition is preferably cooled. Optionally, a stage of intermediate cooling may be performed to provide a pre-cooled fermented composition having a temperature of between about 22° C. and about 4° C. Typically the intermediate cooling time is about 1 hour to about 4 hours, in particular about 1 hour 30 minutes to about 2 hours. The pre-cooled fermented plant-based composition is typically stored for up to 40 hours or less.

Preferably, a stage of final cooling of the fermented plant-based composition is performed such that the temperature at the start of the final cooling is less than about 22° C. and the temperature at the end of the final cooling is about 4° C. to about 10° C. The cooled composition may then be stored, transported and/or distributed at a temperature from about 1° C. to about 10° C. for at least about 30 days, at least about 60 days or at least about 90 days.

According to a further embodiment, the method for the preparation of a fermented plant-based composition as defined above optionally comprises a stage of stirring at a pressure of at least 20 bars, or performing a dynamic smoothing, to obtain a composition having the desired viscosity, typically a viscosity of up to 20 mPa·s. Stirring or dynamic smoothing operations provide some shear to composition that typically allow a viscosity drop. Such operations are known by the one skilled in the art, and can be operated with conventional appropriate equipment. This stage is typically performed at cold temperature, for example at a temperature of form 1° C. to 20° C. Without intending to be bound to any theory, it is believed that applying some shear at cold temperature, typically by stirring at high pressure or by performing a dynamic smoothing, can lead to a fluid gel formation within the composition, that provides improved stability even at a low viscosity of up to 20 mPa·s.

Alternatively, according to a further embodiment, the method for the preparation of a fermented plant-based composition as defined above optionally comprises a stage of straining to provide a “strained fermented plant-based composition”. In this step, an aqueous composition is separated from the curd resulting from the protein coagulation due to acidification during fermentation. Thus, one obtains:
a fermented plant-based composition, typically comprising the proteins coagulum, referred to as a strained fermented plant-based composition, and
an aqueous by-product

Such separation steps are known by the one skilled in art, for example in processes of making “greek yogurts”. The separation can for example be carried out by reverse osmosis, ultrafiltration, or centrifugal separation. The separation step can be performed for example at a temperature of from 30° C. to 45° C.

According to a further embodiment, the method for the preparation of a fermented plant-based composition as defined above optionally comprises a stage of addition of an intermediate preparation as described above prior or subsequent to fermentation, said intermediate preparation typically comprising a preparation of fruits and/or cereals and/or additives such as flavorings and/or colourings.

It is preferred that in embodiments of processes or uses of the invention said fermented plant-based composition is stored at a temperature of from 1° C. to 10° C., preferably under refrigerated conditions for at least 24, 48 or 72 hours after packaging prior to consumption. In other embodiments, the fermented plant-based composition is stored, transported and/or distributed at a temperature of from 1° C. to 10° C. for at least about 1, 5, 6, 7, 8, 9, 10, 12, 14, 16, 18, 20, 22, or 24 days prior to consumption.

### Further Compositions

The combination of CNCM 1-1631 and CNCM 1-1520 as described herein is useful in the preparation of food products, such as fermented products. Accordingly, in a third aspect, the present invention provides compositions comprising CNCM 1-1631 and CNCM 1-1520.

The combination of CNCM 1-1631 and CNCM 1-1520 as provided herein are suitable for use in edible compositions. Accordingly, in one embodiment, the present invention provides an edible composition suitable for human consumption or ingestion, preferably by oral means comprising CNCM 1-1631 and CNCM 1-1520. The composition comprises or consists of comestible matter. It is particularly preferred that the compositions of embodiments of the invention are substantially free of pathogenic or toxicogenic matter. In a particularly preferred embodiment, the composition according to the invention may be a non-therapeutic composition, preferably a nutraceutical composition, a nutritional composition and/or a food product. It is particularly preferred that the food product is a fermented food product, preferably a fermented dairy composition or plant-based alternative thereto. Further compositions according to embodiments of the invention also include food additives, food ingredients, nutritional formulas, baby foods, infant milk formulas and infant follow-on formulas.

In other embodiments, the edible composition comprises at least 10⁵ cfu, e.g. at least 10⁶ cfu, such as at least 10⁸ cfu CNCM 1-1631 and CNCM 1-1520 per gram of composition. In other embodiments, the edible composition comprises 10⁵ to 10¹² colony forming unit (CFU), or more preferably 10⁶ to 10¹⁰ colony forming unit (CFU) CNCM 1-1631 and CNCM 1-1520 per gram of edible composition.

In a further embodiment, the present invention provides an inoculum comprising CNCM 1-1631 and CNCM 1-1520 that is suitable for the preparation of fermented food products preferably fermented dairy products or plant-based alternatives thereto. In other embodiments, the inoculum of the invention is suitable for the direct inoculation of CNCM I-1631 and CNCM 1-1520 into a composition comprising milk to provide fermented dairy products of the invention, typically without the need for a culture step prior to said direct inoculation.

Typically, the inoculum further comprises excipient or carriers, the selection of which is within the scope of the skilled person but may include buffers or culture media. The inoculum may optionally comprise further components such as cryoprotectants, preservatives and/or additives including nutrients such as yeast extracts, cysteine, sugars and vitamins.

Typically, the inoculum is fresh, frozen, dried or lyophilized. The inoculum may be in liquid, dry, spray-dried or solid form. It is particularly preferred that the inoculum is in liquid form. The inoculum may be defrosted and/or dispersed in liquid (e.g. water) prior to inoculation into a composition comprising milk.

In other embodiments, the inoculum comprises at least 10⁹ cfu, e.g. at least 10¹⁰ cfu, such as at least 10¹¹ cfu each of CNCM 1-1631 and CNCM 1-1520 per gram of inoculum composition. In other embodiments, the inoculum comprises 10⁹ to 10¹² colony forming unit (CFU), or more preferably 10¹⁰ to 10¹² colony forming unit (CFU) CNCM 1-1631 and CNCM 1-1520 per gram of inoculum.

Preferably, the inoculum comprising Streptococcus thermophilus CNCM 1-1631 and CNCM 1-1520 is substantially pure.

In other embodiments, the present invention provides edible compositions or inoculums as described above further comprising additional strains of Bifidobacterium and/or lactic acid bacteria.

Examples of Bifidobacterium that can be used include but are not limited to Bifidobacterium animalis (for example Bifidobacterium animalis subsp. animalis or Bifidobacterium animalis subsp. lactis); Bifidobacterium longum; Bifidobacterium breve; Bifidobacterium bifidum, Examples of lactic acid bacteria that can be used include but are not limited to Lactobacilli (for example Lactobacillus acidophilus, Lactobacillus buchneri, Lactobacillus delbrueckii, in particular L. delbrueckii subsp. bulgaricus or lactis, Lactobacillus casei, Lactobacillus plantarum, Lactobacillus reuteri, Lactobacillus johnsonii, Lactobacillus helveticus, Lactobacillus brevis, Lactobacillus rhamnosus); Lactococci (for example Lactococcus lactis, typically Lactococcus lactis subsp. lactis or Lactococcus lactis subsp. cremoris). In embodiments said strains are selected from the group comprising Bifidobacteria; Lactobacillus acidophilus; Lactobacillus casei and/or combinations thereof. Preferably, the inoculum mixture further comprises Lactobacillus and/or Streptococcus. For the preparation of yogurt or yogurt alternatives, the inoculum mixture typically comprises Lactobacillus bulgaricus (also referred to as Lactobacillus delbruckeii subsp. bulgaricus) and Streptococcus thermophilus, optionally with additional microorganisms such as but not limited to probiotic species or other species that may provide desirable organoleptic or other qualities to the composition, e.g. additional Lactococcus lactis. In embodiments the composition comprises at least 10⁵ cfu, e.g. at least 10⁶ cfu, 10⁷ cfu, 10⁸ cfu, 10⁹ cfu or 10¹⁰ cfu, such as at least 10¹¹ cfu per gram of composition of each of said additional strains.

Accordingly, in one embodiment, the present invention provides an edible composition or inoculum as described above comprising a CNCM 1-1631 and CNCM 1-1520 and further comprising at least one strain of Lactobacillus bulgaricus and optionally one or more additional strains of S. thermophilus and/or Bifidobacterium.

Lactococcus lactis strain CNCM 1-3437

In a fourth aspect, the present invention provides a strain of Lactococcus lactis subsp. lactis. In embodiments, the Lactococcus lactis subsp. lactis strain of the invention is characterized in that it is capable of secreting diacetyl is suitable for use in fermentation of vegetal bases and provides improved organoleptic characteristics to fermented products. The present invention provides the strain Lactococcus lactis subsp. lactis CNCM 1-3437. This strain has been deposited at the Collection Nationale de Cultures de Microorganismes (CNCM) (Institut Pasteur, 25 Rue du Docteur Roux, Paris, France) under the Budapest Treaty on May 25, 2005 under reference number CNCM 1-3437. The deposit was made in accordance with the Budapest Treaty on the International Recognition of the Deposit of Microorganisms for the Purposes of Patent Procedure, as provided therein the applicant requests that a sample of the deposited micro-organisms only be made available to an independent expert, until the date on which the patent may be granted. In one embodiment, the present invention provides the isolated strain Lactococcus lactis subsp. lactis CNCM 1-3437, preferably said isolate is substantially pure.

Compositions Comprising Lactococcus lactis Strain CNCM 1-3437

In further embodiments, the present invention provides compositions comprising Lactococcus lactis subsp. lactis CNCM 1-3437. Preferably, the composition comprises at least 10⁶, more preferably at least 10⁷ and most preferably at least 10⁸ colony forming unit (CFU) Lactococcus lactis subsp. lactis CNCM 1-3437 per gram (g) of composition according to embodiments of the invention.

In other embodiments, the composition comprises 10⁵ to 10¹² colony forming unit (CFU) Lactococcus lactis subsp. lactis CNCM 1-3437 per gram (g) of composition according to embodiments of the invention. In further embodiments, the composition comprises 10⁶ to 10¹¹ colony forming unit (CFU) Lactococcus lactis subsp. lactis CNCM 1-3437 per gram (g) of composition according to embodiments of the invention.

The bacterium as provided herein is suitable for use in edible compositions. Accordingly, in one embodiment, the present invention provides a composition suitable for human consumption or ingestion, preferably by oral means. The composition comprises or consists of comestible matter. It is particularly preferred that the compositions of embodiments of the invention are substantially free of pathogenic or toxicogenic matter. In a particularly preferred embodiment, the composition according to the invention may be a non-therapeutic composition, preferably a nutraceutical composition, a nutritional composition and/or a food composition. It is particularly preferred that the food composition is a fermented food composition, preferably a fermented dairy composition. Further compositions according to embodiments of the invention also include food additives, food ingredients, nutritional formulas, baby foods, infant milk formulas and infant follow-on formulas. In other embodiments, the composition of the invention may be an inoculum suitable for the preparation of fermented food products.

The composition may comprise further additional strains of Bifidobacterium and/or lactic acid bacteria, typically 1, 2, 3, 4 or more additional strains as described in previous embodiments of the invention. In embodiments the composition comprises at least 10⁵ cfu, e.g. at least 10⁶ cfu, 10⁷ cfu, 10⁸ cfu, 10⁹ cfu or 10¹⁰ cfu, such as at least 10¹¹ cfu per gram of composition of each of said additional strains.

In one embodiment, the present invention provides a plant-based composition, preferably a fermented plant-based composition comprising Lactococcus lactis subsp. lactis CNCM 1-3437 as described in previous embodiments of the invention.

In another embodiment, the present invention provides a dairy composition comprising, preferably a fermented dairy composition comprising Lactococcus lactis subsp. lactis CNCM I-3437. The dairy composition of the invention comprises milk, preferably fermented milk. Preferably the composition comprises at least about 30% (w/w) milk, more preferably at least about 50% (w/w) milk and even more preferably at least about 70% (w/w) milk. In other embodiments, the composition comprises at 30% to 100% (w/w) milk. In embodiments, the composition comprises 50% to 100% (w/w) milk. In embodiments, the composition comprises 70% to 100% (w/w) milk. Preferably, said milk is goat, ewe, camel, mare, cow milk or combinations thereof, and most preferably to cow milk. Preferably, said milk(s) are heat-treated, typically pasteurized, to ensure sterility. Preferably, said heat treatment is carried out prior to the preparation of the fermented dairy composition.

Preferably, said milk comprises one or more of skimmed, partially-skimmed or non-skimmed milk. Preferably, said milk or milks may be in liquid, powdered and/or concentrated form. In one embodiment said milk further comprises milk components preferably selected from the group consisting of cream, casein, caseinate (for example calcium or sodium caseinate), whey proteins notably in the form of a concentrate (WPC), milk proteins notably in the form of a concentrate (MPC), milk protein hydrolysates, and mixtures thereof. In one embodiment said mixture further comprises plant and/or fruit juices. In one embodiment, said milk or milks may be enriched or fortified with further milk components or other nutrients such as but not limited to vitamins, minerals, trace elements or other micronutrients.

In a further embodiment, the present invention provides an inoculum comprising CNCM 1-3437 that is suitable for the preparation of fermented food products preferably fermented dairy products or plant-based alternatives thereto. In other embodiments, the inoculum of the invention is suitable for the direct inoculation of CNCM 1-3437 into a composition comprising milk or a dairy-free vegetal base to provide fermented products of the invention, typically without the need for a culture step prior to said direct inoculation.

Typically, the inoculum further comprises excipient or carriers, the selection of which is within the scope of the skilled person but may include buffers or culture media. The inoculum may optionally comprise further components such as cryoprotectants, preservatives and/or additives including nutrients such as yeast extracts, cysteine, sugars and vitamins.

Typically, the inoculum is fresh, frozen, dried or lyophilized. The inoculum may be in liquid, dry, spray-dried or solid form. It is particularly preferred that the inoculum is in liquid form. The inoculum may be defrosted and/or dispersed in liquid (e.g. water) prior to inoculation into a composition comprising milk.

In other embodiments, the inoculum comprises at least 10⁹ cfu, e.g. at least 10¹⁰ cfu, such as at least 10¹¹ cfu each of CNCM 1-3437 per gram of inoculum composition. In embodiments, the inoculum comprises 10⁹ to 10¹² colony forming unit (CFU), or more preferably 10¹⁰ to 10¹² colony forming unit (CFU) CNCM 1-3437 per gram of inoculum.

Preferably, the inoculum comprising Lactocococcus CNCM 1-3437 is substantially pure.

In other embodiments, the present invention provides edible compositions or inoculums as described above further comprising additional strains of Bifidobacterium and/or lactic acid bacteria, typically 1, 2, 3, 4 or more additional strains. In embodiments the composition comprises at least 10⁵ cfu, e.g. at least 10⁶ cfu, 10⁷ cfu, 10⁸ cfu, 10⁹ cfu or 10¹⁰ cfu, such as at least 10¹¹ cfu per gram of composition of each of said additional strains.

Examples of Bifidobacterium that can be used include but are not limited to Bifidobacterium animalis (for example Bifidobacterium animalis subsp. animalis or Bifidobacterium animalis subsp. lactis); Bifidobacterium longum; Bifidobacterium breve; Bifidobacterium bifidum. Examples of lactic acid bacteria that can be used include but are not limited to Lactobacilli (for example Lactobacillus acidophilus, Lactobacillus buchneri, Lactobacillus delbrueckii, in particular L. delbrueckii subsp. bulgaricus or lactis, Lactobacillus casei, Lactobacillus plantarum, Lactobacillus reuteri, Lactobacillus johnsonii, Lactobacillus helveticus, Lactobacillus brevis, Lactobacillus rhamnosus); Lactococci (for example Lactococcus lactis, typically Lactococcus lactis subsp. lactis or Lactococcus lactis subsp. cremoris). In embodiments said strains are selected from the group comprising Bifidobacteria; Lactobacillus acidophilus; Lactobacillus casei and/or combinations thereof. Preferably the inoculum mixture further comprises Lactobacillus and/or Streptococcus. For the preparation of yogurt or yogurt alternatives, the inoculum mixture typically comprises Lactobacillus bulgaricus (also referred to as Lactobacillus delbruckeii subsp. bulgaricus) and Streptococcus thermophilus, optionally with additional microorganisms such as but not limited to probiotic species or other species that may provide desirable organoleptic or other qualities to the composition, e.g. additional Lactococcus lactis.

Accordingly, in one embodiment, the present invention provides an edible composition or inoculum as described above comprising a CNCM 1-3437 and further comprising at least one strain of Lactobacillus bulgaricus and optionally one or more additional strains of S. thermophilus and/or Bifidobacterium.

The compositions of the invention can be used as a plant-based fermented milk alternative as described above. The invention will be further illustrated by the following non-limiting Examples.

### EXAMPLES

### Materials & Methods

Organic acids were analyzed using High Performance Liquid Chromatography coupled with Spectrophometric detection (in the UV field). HPLC-UV was performed using an Ultimate 3000 equipment (Thermofisher).

Prior to analysis, samples were homogenized, diluted with MilliQ water, filtrated (0.2 μm) and injected into the chromatographic system. Separation was carried out using a cation exchange column IC SEP ICE COREGEL 87H3-300×7.8 mm from Transgenomic (INTERCHIM). After separation, organic acids were detected by spectrophotometric detection. Quantification was performed by calibration using standards solutions analyzed exactly in the same conditions.

### Example 1: High Acetic Acid Content in Plant-Based Probiotic Yogurt Alternative

### Culture 1:

A plant-based probiotic culture was provided in frozen form and defrosted for inoculation.

The culture comprised:
Lactobacillus delbrueckii subsp. bulgaricus (“LB”) CNCM 1-1632,
Lactobacillus delbrueckii subsp. bulgaricus (“LB”) CNCM 1-1519,
Streptococcus thermophilus (“ST”) CNCM-1630,
Lactococcus lactis subsp. lactis (“LC”) CNCM-1631, and
Bifidobacterium animalis subsp. lactis (“BIF”) CNCM-2494

Fermented milk test products were prepared by inoculating cow milk (control) and soy milk (soy, water, antioxidant, sea salt) with the culture (0.08% volume) and incubating at 40° C. until a pH of 4.6 was reached. Fermentation was stopped by rapid cooling followed by storage at 4° C. overnight and then at 10° C. Acetic and lactic acid in the fermented products was measured as described above at 3 days of storage.

Fermentation was carried out in batches of 1.5 L (for pH testing) and concurrently in 125 mL yogurt pots (8 pots) for fermentation metabolite testing.

TABLE 1

| | Acetic Acid mg/100 g | Lactic Acid mg/100 g |
|---|---|---|
| Cow milk | 36 | 684 |
| Soy milk | 160 | 140 |

Surprisingly, it was found that fermentation of soy milk took extremely long (22 h28 minutes to reach pH 4.6, pH 4.73 was reached at 11 h) and resulted in a product having a significantly higher amount of acetic acid. The culture produced about 5 times more acetic acid (z160 mg/100 g vs z36 mg/100 g) and 5 times less lactic acid (z140 mg/100 g vs z684 mg/100 g) in the soy milk matrix compared to a milk matrix.

The ratio of lactic:acetic acid in the control (cow milk) product was 19:1 (“19”), whereas in the soy product it was 1:0.88 (“0.88”).

Acetic acid contributes vinegary or sour notes to the final product which was detected by a tasting panel.

Neither acetic nor lactic acid were detected in the unfermented soy milk, as the B. lactis was the sole heterofermentative (acetic acid producing) strain it is assumed that the B. lactis is growing faster in soy than in cow milk.

Furthermore, the fermented soy milk had less diacetyl than would be expected in L. lactis containing dairy yogurts. Diacetyl is a fermentation metabolite associated with creamy and buttery notes. Further experiments indicated that the level of diacetyl in the soy product at Day 5 was 50% less than at Day 12 indicating that the viable L. lactis in the product may continue to produce diacetyl during shelf-life.

Accordingly, it was determined that in order to provide an improved organoleptic experience for healthy (low sugar and containing probiotic bacteria) plant based yogurt alternatives closer to that of the dairy equivalent and other soy based equivalents, there was a need for
1) reducing the amount of acetic acid and to provide a higher lactic:acetic acid ratio in the fermented plant-based product containing heterofermentative bacteria to provide a less acidic vinegary tasting product, and also
2) maintaining good levels of L. lactis during shelf-life to ensure creamy and buttery notes (from diacetyl)

Three approaches were tested:
i) Experiments were repeated at fermentation temperatures of 37° C. & 40° C. with a target pH of 4.6, and also fermentation temperatures of 40° C. with a target pH of 4.7. These experiments confirmed the findings of Table 1 (slightly higher acetic acid than lactic acid) with no significant differences observed by the change in fermentation temperature or target pH.
ii) Additional strains of bacteria were added to the cultures (Example 2).
iii) Small amounts of additional sugars were added to the mixture (Example 3).
   Surprisingly, it was found that the addition of a fructose positive S. thermophilus strain significantly increased the rate of fermentation, provided a good lactic/acetic acid balance and may improve L. lactic survival.

### Example 2: Reduction of Acetic Acid Content Using Cultures

Additional homofermentative cultures were tested to determine their effect on lactic & acetic acid content:

Culture 2: Culture 1+Streptococcus thermophilus strain CNCM 1-1520 (0.02% volume). The strain is known for the preparation of fermented dairy analogues using a mixed soy+cereal hydrolysate base (U56699517). However, tests in soy milk (see Example 1 above, no added cereal hydrolysate or almond milk) indicated that fermentation time was 10+ hours to reach yogurt alternative pH. This was not observed in U56699517 (hereby incorporated by reference), which is due to the presence of the cereal hydrolysate providing mono- & di-saccharides to the fermentation mixture. Nevertheless, the strain was tested as it is a homofermentative fructose positive Streptococcus thermophilus strain.

Culture 3: Culture 1+raffinose metabolizing homofermentative strain Lactobacillus acidophilus CNCM 1-2273 (0.02% volume).

Soy milk contains raffinose and stachyose, which can be metabolized by Bifidobacteria spp. but not the lactic acid bacteria of culture 1. It was hypothesized that the raffinose in the soy milk was being consumed solely by the Bifidobacteria resulting in the increase in acetic acid, thus a further raffinose metabolizing homofermentative strain acidophilus CNCM 1-2273 was provided in culture 3 to outcompete the Bifidobacteria.

Fermented soy milk products were prepared as in Example 1.

### Results

Culture 2: Fermentation time to reach pH 4.6 was 7 h 4 minutes. Lactic acid content of the fermented product was significantly increased to 311.6+/−15.6 mg/100 g and acetic acid content reduced to 120.8+/−6.0 mg/100 g, providing a product with a ratio of lactic:acetic acid in the product of 2.59:1. A tasting panel of volunteers indicated a reduction in the vinegar notes and increase in creaminess over the products of Example 1, and thus the product was considered to be organoleptically closer to that of the dairy equivalent.

Culture 3: Fermentation time to reach pH 4.6 was 8 h 26 minutes. Tasting panel indicated that the product tasted even more acidic than products of culture 2.

Surprisingly, it was possible to mitigate these organoleptic issues of Example 1 by the addition of a homofermentative strain capable of reducing fermentation time to pH 4.6 in under 8 hours. The faster pH reduction is likely due to increased production of lactic acid as opposed to acetic acid, as the former has a significantly lower pka value.

### Example 3: Reduction of Fermentation Times by Adding Sugars

As an alternative solution, various different sugars were added to the soy matrix of Example 1 to increase the metabolic activity of non-Bifidobacteria strains of Culture 1. As lactic acid is the principle acidifying component during the fermentation, time to pH 4.6 is considered to be an indicator of the lactic acid content. None of the various sugar additions were able to reduce time to pH 4.6 as significantly as culture 2 (see Table 2).

TABLE 2

| | pH start of | pH end of | Time for |
|---|---|---|---|
| Mixture* | fermentation | fermentation | fermentation |
| Example 1 | 6.28 | 4.73 | 11:00 |
| Soy milk + | | | |
| Culture 1 | | | |
| Example 1 | 6.4 | 4.6 | 10:00 |
| Soy milk + | | | |
| Culture 1 + | | | |
| Dextrose 0.25% | | | |
| Example 1 | 6.24 | 4.6 | 07:10 |
| Soy milk + | | | |
| Culture 1 + | | | |
| Dextrose 0.50% | | | |
| Example 1 | 6.39 | 4.6 | 10:34 |
| Soy milk + | | | |
| Culture 1 + | | | |
| Sucrose 0.25% | | | |
| Example 1 | 6.31 | 4.6 | 08:56 |
| Soy milk + | | | |
| Culture 1 | | | |
| Sucrose 0.50% | | | |
| Example 1 | 6.26 | 4.6 | 07:54 |
| Soy milk + | | | |
| Culture 1 + | | | |
| Sucrose 0.15% + | | | |
| Dextrose 0.15% | | | |
| Example 2 | 6.33 | 4.6 | 08:26 |
| Soy milk + | | | |
| Culture 3 | | | |
| Example 2 | 6.3 | 4.6 | 07:04 |
| Soy milk + | | | |
| Culture 2 | | | |

*% volume of total volume of mixture

Thus, it was demonstrated that the addition of low DP sugars did not reduce the fermentation time, this demonstrates for the first time that no added sugar or low added sugar type plant-based products of this type could be prepared. Accordingly, an aim of the invention is to provide plant-based fermented dairy alternative products (e.g. yogurt substitutes) are free from, or do not comprise, added sugars.

### Example 4: Bacterial Counts Over Shelf-Life

Bacterial counts (log CFU) were determined at the end of fermentation and days 4, 21 & 35 of storage of fermented products prepared according to Example 2. Table 3 provides the average Log CFU of multiple fermentations carried out according to Examples 1 (Culture 2) and 2 (Culture 2) carried out as matched tests (i.e. for each fermentation tested both cultures 1 & 2 were tested in the same conditions).

TABLE 3
Log CFU cultures (fermented soy milk)

| | D4 | | | | D21 | | | | D35 | | | |
|---|---|---|---|---|---|---|---|---|---|---|---|---|
| | ST | LB | LC | BIF | ST | LB | LC | BIF | ST | LB | LC | BIF |
| Culture | 6.51 +/− | 5.96 +/− | 6.19 +/− | 8.47 +/− | 4.83 +/− | 4.47 +/− | 5.31 +/− | 8.02 +/− | 3.71 +/− | 3.37 +/− | 5.18 +/− | 8.42 +/− |
| 1 | 0.81 | 0.51 | 0.87 | 0.60 | 0.67 | 0.95 | 0.83 | 0.52 | 0.59 | 0.79 | 1.45 | 0.64 |
| Culture | 6.89 +/− | 5.66 +/− | 5.82 +/− | 8.76 +/− | 5.58 +/− | 4.89 +/− | 5.72 +/− | 8.35 +/− | 5.21 +/− | 3.67 +/− | 5.82 +/− | 8.26 +/− |
| 2 | 0.77 | 0.25 | 0.68 | 0.38 | 1.22 | 0.94 | 1.06 | 0.34 | 1.14 | 0.79 | 1.04 | 0.46 |

Surprisingly, it was observed that the addition of CNCM 1-1520 may improve the survival of L. lactis (“LC”) during shelf life, without this strain a 1 log reduction in L. lactis was observed at Day 35.

Although initial (Day 4) counts of L. lactis (“LC”) were not increased by the addition of CNCM 1-1520 during shelf life (up to Day 35) there was a faster decrease in L. lactis count in Culture 1, whereas Culture 2 appeared to maintain or limit the reduction of L. lactis count.

As discussed under Example 1, good survival of L. lactis during shelf life is associated with increased diacetyl levels during shelf life. Thus, the addition of a homofermentative fructose positive Streptococcus thermophilus strain such as CNCM 1-1520 could be useful to improve L. lactis viability and thus organoleptic properties of the product.

To demonstrate this the inventors carried out sensory assessments of fermented products prepared according to Example 2. Control products were prepared using Culture 1, test products were prepared using Culture 1+0.02% CNCM 1-1520, fermentation of the soy base was carried out at 40° C.

and confirmed that the addition of CNCM 1-1520 reduced bitter notes and increased creamy notes and mildness in the product. Surprisingly no significant difference in post-acidification was observed.

### Example 5

The inventors confirmed the “dairy-like” attributes of Lc. lactis fermented plant-based dairy alternatives in a hydrolysed cereal matrix using alternative Lc. lactis in combination with yogurt cultures. The sensory characteristics of Lc. lactis fermented plant-based dairy alternatives was tested against a panel of fermented products prepared using yogurt cultures, in some cases also supplemented with “probiotic” species but that did not contain Lc. lactis.

The hydrolysed cereal base consisted of Natu-Oat syrup 35 (Meurens™), sugar, pea protein, tapioca starch, rapeseed oil & water. The hydrolysed cereal base was inoculated with test cultures and cultured at 43° C. to a pH of 4.6.

In total a panel of 16 cultures were tested. Each culture contained the typical yogurt cultures S. thermophilus & L. Bulgaricus, in addition some test cultures also contained probiotic species (L. casei, B. lactis, L. acidophilus). Only “Test Culture Lc. lactis” contained Lc. lactis.

“Test Culture Lc. lactis” contained the species S. thermophilus, L. Bulgaricus, L. acidophilus, L. casei, Lc. lactis lactis (CNCM 1-3437) & Lc. lactis cremoris (CNCM 1-3558). It was the sole culture in the panel to be tested that contained Lc. lactis species.

The sensory characteristics of the fermented products was then tested by a trained tasting panel. As demonstrated in Table 4, Test Culture Lc. lactis was the sole plant-based dairy alternative characterized as having “milk notes”.

TABLE 4

| | | | | | | | Rice | | | | | |
|---|---|---|---|---|---|---|---|---|---|---|---|---|
| | Oat | | Arti | Palm | | Soy | cooking | Pra | Milk | Green | Warm | |
| CULTURES | flakes | Nuts | choke | heart | Mushroom | Milk | water | line | notes | notes | notes | Bitterness |
| Culture 1 | 1 | 3 | | 3 | | | | | | | | 2 |
| Culture 2 | | 1 | | 2 | | | | | | | | 2 |
| Culture 3 | | | | 2 | 1 | | | | | | | 2 |
| Culture 4 | 1 | | | 2 | 2 | 4 | | | | | | 2 |
| Culture 5 | 1 | | | 2 | 4 | | | | | | | 3 |
| Culture 6 | 4 | 2 | | 1 | | | | | | | | 1 |
| Culture 7 | 0 | 3 | | 2 | | | | | | | | 2 |
| Culture 8 | 1 | 4 | | | | 1 | | | | | | 1 |
| Culture 9 | | | | | | 1 | | 2 | | | | 1 |
| Culture 10 | 3 | | | | | 3 | | | | | 2 | 1 |
| Culture 11 | 2 | | | | | | 2 | | | | | 1 |
| Culture 12 | | | 2 | 3 | | | | | | | | 2 |
| Culture 13 | | | | 1 | 4 | | | | | | | 2 |
| Culture 14 | 0 | 2 | | | 3 | | | | | | | 1 |
| Culture 15 | | 0 | | 3 | | | | | | 4 | | 1 |
| Test | 1 | | | | 1 | | | | 4 | | | 0.5 |
| Culture | | | | | | | | | | | | |
| Lc. lactis | | | | | | | | | | | | |

HPLC analysis of a Test Culture Lc. lactis plant-based dairy alternative product was tested for volatile organic compounds before and after fermentation. Fermentation resulted in an increase of VOCs associated with butter/creamy notes including diacetyl & acetoin (these compounds were not present in the unfermented vegetal base).

Fermentability of Test Culture Lc. lactis was confirmed in coconut and almond bases.

This analysis confirms that the addition of Lc. lactis to a yogurt culture for the preparation of plant-based fermented dairy alternative products results in a yogurt type product having a closer organoleptic profile to that of a dairy product, surprisingly in addition to improved milky notes the product is characterized by decreased bitterness. Thus Lc. lactis strains could be used to improve the dairy-like taste of plant-based yogurts, in particular those containing “probiotic” species that may impart unwanted tastes. Such strains are selected primarily for their potential health benefit (rather than taste criteria), as seen in the previous Examples the effect of B. animalis lactis on taste is especially pronounced in plant bases as compared to dairy. The present Example confirms the beneficial organoleptic profile of a Lc. lactis yogurt alternative prepared using additional probiotic type species L. acidophilus & L. casei. Thus it has been demonstrated that in plant-based fermented dairy alternative products it is surprisingly advantageous to include Lc. lactis in the fermentation culture, and could potentially contribute to counteract unwanted organoleptics associated with probiotic species.

1. A process for the preparation of a fermented plant-based food product comprising
a) providing a mixture comprising:
i) a vegetal base, and
ii) Lactococcus species; and
b) fermenting the mixture to provide a fermented plant-based food product.

2. The process according to claim 1, wherein said mixture further comprises iii) S. thermophilus and/or L. bulgaricus.

3. The process according to claim 1, wherein said mixture further comprises
iii) fructose positive S. thermophiles.

4. The process according to claim 1, further comprising c) packaging and storing the product for at least 24 hours.

5. A fermented plant-based dairy-alternative food product comprising:
i) a fermented vegetal base, and
ii) a Lactococcus species.

6. The fermented plant-based dairy-alternative food product according to claim 5, wherein said product further comprises iii) S. thermophilus and/or L. bulgaricus.

7. A plant-based food product comprising:
i) a fermented vegetal base,
ii) Lactococcus species, and
iii) fructose positive S. thermophilus.

8. The process according to claim 1, wherein the Lactococcus is Lc. lactic.

9. The process according to claim 1, wherein the Lactococcus comprises diacetyl and/or acetoin producing strain(s).

10. The process according to claim 1, wherein the Lactococcus comprises one or more strains selected from the group consisting of CNCM 1-1631; CNCM 1-3437; CNCM 1-3558 and/or combinations thereof.

11. The process according to claim 1, wherein the fermented product comprises diacetyl and/or acetoin.

12. The process according to claim 2, wherein the S. thermophilus is fructose positive and optionally comprises CNCM 1-1520.

13. The process according to claim 1, wherein the vegetal base comprises plant-matter selected from the group consisting of pulse, cereal, nut and/or combinations thereof.

14. The process according to claim 1, wherein the vegetal base does not comprise almond milk or fully or partially hydrolyzed plant-matter.

15. (canceled)

16. (canceled)

17. The product according to claim 5, wherein the product is characterized by increased buttery, increased creamy, increased dairy notes, decreased bitterness and/or combinations thereof.

18. (canceled)

19. The process according to claim 2, wherein iii) further comprises one or more strains of bacteria selected from the group consisting of Bifidobacterium animalis; Bifidobacterium longum; Bifidobacterium breve; Bifidobacterium bifidum; Lactobacillus acidophilus; Lactobacillus buchneri; Lactobacillus casei; Lactobacillus plantarum; Lactobacillus reuteri; Lactobacillus johnsonii; Lactobacillus helveticus; Lactobacillus brevis; Lactobacillus rhamnosus and/or combinations thereof.

20. The product according to claim 5, wherein the Lactococcus is Lc. lactic.

21. The product according to claim 5, wherein the Lactococcus comprises diacetyl and/or acetoin producing strain(s).

22. The product according to claim 5, wherein the Lactococcus comprises one or more strains selected from the group consisting of CNCM 1-1631; CNCM 1-3437; CNCM 1-3558 and/or combinations thereof.

23. The product according to claim 5, wherein the fermented product comprises diacetyl and/or acetoin.

24. The product according to claim 6, wherein the S. thermophilus is fructose positive and optionally comprises CNCM 1-1520.

25. The product according to claim 5, wherein the vegetal base comprises plant-matter selected from the group consisting of pulse, cereal, nut and/or combinations thereof.

26. The product according to claim 5, wherein the vegetal base does not comprise almond milk or fully or partially hydrolyzed plant-matter.

27. The product according to claim 5, wherein the product is characterized by increased buttery, increased creamy, increased dairy notes, decreased bitterness and/or combinations thereof.

28. The product according to claim 6, wherein iii) further comprises one or more strains of bacteria selected from the group consisting of Bifidobacterium animalis; Bifidobacterium longum; Bifidobacterium breve; Bifidobacterium bifidum; Lactobacillus acidophilus; Lactobacillus buchneri; Lactobacillus casei; Lactobacillus plantarum; Lactobacillus reuteri; Lactobacillus johnsonii; Lactobacillus helveticus; Lactobacillus brevis; Lactobacillus rhamnosus and/or combinations thereof.
